(19) United States
(12) Patent Application Publication
(10) Pub. No.: US 2025/0103972 A1
(43) Pub. Date: Mar. 27, 2025

(54) METHOD FOR ARRANGING VEHICLE-RELATED SERVICES, AND FLEET MANAGEMENT PLATFORM

(71) Applicant: MERCEDES-BENZ GROUP AG, Stuttgart (DE)

(72) Inventors: Merve KAYA, Deißlingen (DE); Christian WARTH, Besigheim (DE)

(21) Appl. No.: 18/294,682

(22) PCT Filed: Jul. 22, 2022
(86) PCT No.: PCT/EP2022/070661

§ 371 Date: Feb. 2, 2024

(30) Foreign Application Priority Data
Aug. 5, 2021 (DE) 10 2021 004 045.7

(51) Int. Cl. G06Q 10/02; B60W 60/00; G06Q 50/10

(52) U.S. Cl. CPC G06Q 10/02; B60W 60/0025; G06Q 50/10

(57) ABSTRACT

Vehicle-related services are arranged by a vehicle determining a service need and transmitting it together with additional data to a central management device. A service provider offers at least one service and transmits service provision information connected with providing the service to the central management device. The central management device produces a contact between the vehicle and the surface provider to provide the service. The vehicle belongs to a vehicle fleet. The additional data includes at least one use of the vehicle planned within a pre-determined period of time. The central management device automatically suggests or books an appointment for the vehicle for the provision of the service, taking into account the planned use of the vehicle and the service provision information, such that a downtime for the vehicle due to the provision of the service and/or costs associated with the operation of the vehicle fleet can be minimized.

### BACKGROUND AND SUMMARY OF THE INVENTION

Exemplary embodiments of the invention relate to a method for arranging vehicle-related services and to a fleet management platform for carrying out the method.

Despite advancing digitization, vehicle fleets are currently still largely managed manually. This results in comparatively inefficient operations for a fleet manager. The fleet manager must thus, in particular, record and manually analyze a plurality of different vehicle-related data, which takes a significant amount of time in relation to automated data processing. For example, the fleet manager must monitor upcoming service appointments, upcoming cleaning work or the like using databases or excel spreadsheets, and ensure that the vehicle-related services to be carried out are carried out as appointed. Errors can thus arise due to human error, whereby an appointment-critical vehicle-related service is not carried out, or is carried out too late.

Vehicle fleets are used by different enterprises or authorities. Thus, for example, a vehicle fleet can be operated by a vehicle manufacturer or car dealership, in order, for example, to provide replacement cars for customers who bring their own vehicle to a garage, for example for a service appointment. Further examples for vehicle fleets are a car-sharing fleet, a ride-sharing fleet, fleet vehicles of a food delivery service, a vehicle fleet of a supermarket chain, a business fleet, vehicles for a car subscription service or the like.

A digital assistant for vehicle-related activities is known from US 2019/0108567 A1. The digital assistant disclosed in the document has the task of reducing work involved for a vehicle user, in particular the vehicle owner, in managing their own vehicle, and thus of saving the vehicle user time and/or money. The digital assistant monitors user data, such as an appointment calendar of the user, vehicle information, such as a vehicle status, vehicle service information or the like, and connects the user data to the vehicle information, taking into account rules, in order to display instructions to the user for carrying out vehicle-related services, such as carrying out maintenance, repairs or selling the vehicle. The digital assistant can also process marketplace information in order to automatically suggest suitable service providers for carrying out the vehicle-related service to the vehicle user, or to directly book the service to be carried out at such a service provider. The rules, according to which the digital assistant transmits instructions or suggests a suitable service provider, are however comparatively simple. Thus, for example, a service provider who offers a particularly cheap price is suggested. Although comfort is thus improved for a vehicle user, because the vehicle user saves time due to the instructions provided by the digital assistant, the actual added value, for example in the form of money saved, is comparatively low.

Exemplary embodiments of the present invention are directed to an improved method for arranging vehicle-related services, using which the amount of work for a vehicle fleet manager is significantly reduced, and in addition the vehicle fleet managed by the vehicle fleet manager can be operated in a particularly cost-efficient manner.

In a method for arranging vehicle-related services, at least one vehicle determines a service need, and transmits the latter to a central management device together with additional data, wherein according to the invention, the vehicle belongs to a vehicle fleet, and the additional data comprises at least one use of the vehicle planned within a pre-determined period of time, and the central management device is equipped to automatically suggest or book an appointment for the vehicle for the provision of the service, taking into account the planned use of the vehicle and service provision information, such that a downtime for the vehicle due to the provision of the service and/or costs associated with the operation of the vehicle fleet can be minimized.

The method according to the invention makes it possible to manage vehicle fleets automatically, whereby the amount of work for a vehicle fleet manager is significantly reduced. In addition, the method according to the invention makes it possible to intelligently plan how vehicle-related services are carried out, such that the downtime for a corresponding vehicle is minimized. The corresponding vehicle is thus in the position to be used to generate revenue for longer, which allows a particularly cost-efficient operation of the vehicle fleet. Thus, for example, the vehicle fleet manager needs to provide fewer vehicles in their vehicle fleet, in order to offset potential downtimes. The total costs for acquiring vehicles, and the running costs for the services to be performed for the individual vehicles during their service life are thus reduced.

The vehicle fleet manager can thus turn their attention to other areas of activity because the management of the vehicle fleet is automatically taken over by the central management device.

The central management device is, for example, a cloud server or server network, which automatically records and analyzes a plurality of items of different data, in order thus to enable an optimal operation of vehicle fleets. A data exchange, i.e., a communication between vehicles, vehicle fleet managers, and service providers can be implemented in many ways. A data transmission between entities involved in the communication can be implemented via wires and/or wirelessly. In particular, the internet is also used for data transmission. A communication between individual entities can be implemented automatically without the involvement of people. This means that machines communicate with each other independently. People can also be involved in the communication. Thus, for example, a vehicle fleet manager and/or service provider can access the data managed by the central management device by means of a front end, in particular a web application and/or software/an application run on a PC or mobile device, and view and/or manipulate the data.

The additional data comprises at least the use of the vehicle that is scheduled for within a pre-determined period of time, for example the next week, the next month or the next quarter. In a delivery vehicle, the planned use can, for example, be using the corresponding vehicle for the corresponding period of time in a fixed operating area, e.g., a busy urban area. The vehicle must not be out of service within this period of time where possible, because otherwise no money can be earned with the vehicle. Using the method according to the invention, the latter is effectively prevented. The central management device is in the position to automatically evaluate and process comparatively large datasets in relation to a manual management by a person. The frequency of human failure is thus reduced, whereby the risk of vehicle downtimes is also minimized.

In particular, the central management device automatically books services to be carried out, whereby the effort involved for a vehicle fleet manager is reduced even further.

The routing to the respective correct provider is crucial for a service. In this context, different aspects should be understood to mean “correct”: On the one hand, the respective service provider must have the suitable competency for the specific need of the vehicle. For example, if a vehicle needs to be washed, it must be guaranteed that the firm that offers the service has a car wash or the like. The “correct” provider must further have the capacity for the service at the correspondingly calculated optimal point in time. As a third aspect, the “correct” provider must be located at the most favorable calculated location for the service of the vehicle depending on the location of the vehicle itself and while taking into account the shortest possible journey time. Datasets such as distances, current traffic data, and fuel or charge level of the vehicle are determined and taken into account. These three aspects are respectively checked and taken into account by the method according to the invention.

In a particularly preferred embodiment of the method according to the invention, so-called distributed ledger technology is used to carry out the method. For example, a blockchain, block-directed acyclic graphs, or transaction-based directed acyclic graphs can be used for this purpose. The entities involved in the method according to the invention, i.e., the vehicles of the vehicle fleet network or their components, a vehicle fleet manager, a service provider, and/or the central management device, can thus sign and exchange intelligent contracts, so-called smart contracts. The method according to the invention can thus be automated even further and be made even safer with regard to cyber-security. This approach is also described as “economy of things”.

An advantageous development of the method provides that a vehicle determines a service need, taking into account at least one of the following parameters:
a distance covered within a pre-determined period of time, in particular a total number of kilometers covered by the vehicle;
a pre-determined elapsed period of time, in particular a service interval;
diagnostic data recorded by the vehicle;
an error code output by the vehicle subsystem;
information about an occurring accident event; and/or
a current or estimated energy reserve of an energy storage device of the vehicle.

A further parameter can be an automatic trigger for a service for a vehicle from the fleet from external accumulated data and the patterns/facts derived from the latter. For example, via the method according to the invention, it can be determined that a vehicle service to be scheduled will be due within a high learned workload curve (period of time such as calendar week or the like) of the fleet in the corresponding area. Based on the accumulated learned workload data, the method can then adapt the corresponding vehicle service such that the service is carried out in a period of time before its actual due date, in which the demand is lower.

A vehicle can generally be any vehicle, such as a passenger car, HGV, transporter, bus, motorbike, moped or also, for example, a micro-vehicle such as an E-scooter or E-bike. The individual vehicle components are used up during the operation of the vehicle. Due to the wear, it is then, for example, necessary to carry out maintenance work. For example, the vehicle fleet manager can thus determine that a vehicle, which has, for example, covered a distance of 100 kilometers, 1000 kilometers or 10,000 kilometers in operation, should be removed from the operation in progress for maintenance. A fixed period of time can also be taken into account for carrying out maintenance, such as a service interval.

The number of “uses” can also be used as a third initial trigger. If, for example, 50 customers cover a distance of 10 km within two weeks, in this case the number of driver changes is decisive as a first rule-based trigger. In the long term, however, these rules can be overwritten based on machine learning in order to obtain an optimal usage of the fleet in the form of downtimes which are as low as possible. Learning algorithms are thus used to derive and predict behavioral patterns and driving styles and the vehicle wear from the user data, and thus to be able to generate intelligent recommendations for fleet operators of all kinds.

The vehicle is then removed from the operation in progress to carry out maintenance, if, first, either the distance covered within the pre-determined period of time has been reached or the pre-determined duration is reached. The central management device monitors the distance covered by all the vehicles of the vehicle fleet and the usage duration. The central management device thus books a corresponding maintenance service to be carried out with a corresponding service provider, for example an approved garage, sufficiently early. The service is booked such that the downtime for the corresponding vehicle is minimized. This means that the service provider not only carries out the corresponding service particularly quickly, but also that a waiting time for the corresponding vehicle between operation and service provision is minimized. A waiting time for a free appointment and a journey time to the service provider are for example factored into the waiting time.

Diagnostic data can, for example, indicate that a component of the vehicle will soon fail. In this case, the vehicle can no longer be operated further. The diagnostic data can also allow an estimation of when there is a risk of a potential failure of the vehicle. The appointment for carrying out the service is correspondingly booked such that the vehicle continues to be operated for as long as possible, and is then removed from the operation in progress for as short a time as possible, and is integrated back into the operation in progress as quickly as possible. In particular for large vehicle fleets, several vehicles require services to be carried out simultaneously. The central management device manages the vehicles and service providers such that, as far as possible, no vehicle is unexpectedly out of service. In particular, vehicle fleets are managed such that no vehicle must wait for a free appointment for a service to be carried out.

In other words, this means that the central management device matches the free capacities to the service needs of the vehicles. If, for example, all the service providers are booked up for a particular period of time, then the services being carried out for a particular number of vehicles are arranged for a period of time in which the corresponding service providers are less booked up. The moved appointments can be arranged for before or after the busy period of time. Vehicles having a particularly urgent service need are then made available correspondingly early for the provision of the corresponding service, and vehicles for which it is possible to wait longer for the provision of the service are then made available for the service to be carried out after the busy period of time.

Corresponding to a further advantageous embodiment of the method, the central management device determines a suitable service provider for providing the service, taking into account at least one of the following pieces of information:
at least one of the following pieces of service provision information: service times of the service provider, free capacities of the service provider, a competency of the service provider, a location at which the service provider offers the service, mobility of the service provider, costs, and/or an availability of parts;
at least one of the following pieces of fleet management information: a unique vehicle identifier, a current or planned stopping place of the vehicle, a number of booked services and/or the presence of a discount agreement; and/or
at least one of the following pieces of environment information: a current or future traffic volume on a route driven by the vehicle before and/or after the service is provided, infrastructure information and/or weather information.

Carrying out particular services also requires a very particular service provider to be selected by the central management device. In addition to the goal of minimizing the downtime of the corresponding vehicle, at least one further secondary condition can also be fulfilled. For this purpose, all relevant conditions for carrying out a service can be weighed up by means of a cost function. For a vehicle fleet manager, the total costs of the operation of the vehicle fleet are in particular relevant.

It can potentially be the case that it is significantly cheaper to carry out a particular service at a particular service provider than at another service provider. If the cheap service provider is further away from a stopping place of a corresponding vehicle than the expensive service provider, the vehicle is out of service for longer due to the further distance from the service carried out at the cheap service provider than when the service is carried out at the expensive service provider. However, because the total costs are lower, taking into account the downtime of the vehicle and the costs of providing the service, if the service of the corresponding vehicle is carried out at the expensive service provider, carrying out the service at the expensive service provider is booked by the central management unit.

Potentially, not all the necessary parts to completely provide a service are available at the first service provider. In this case, a suitable service provider is then selected, which has the corresponding parts in storage or can obtain the corresponding parts in good time.

It is self-explanatory that carrying out a service can only be booked if the service provider has opened, i.e., in the operating hours of the service provider, and the service provider also has free capacity, i.e., appointments, available, wherein the actual booking process can be implemented by the central management device at any time, and thus also if the corresponding service provider has just closed. The central management device distributes the different vehicles of the vehicle fleet intelligently to different service providers, such that the total costs for the operation of the vehicle fleet are minimized for the vehicle fleet manager. All relevant costs for carrying out a service are takes into account. For this purpose, the central management device is more suitable than a person, because the central management device automatically harvests and manages relevant information. The central management device can engage in the management processes at any depth.

The following example should clarify this: If, for example, a first number of vehicles require a particular, comparatively rarely used and expensive replacement part, whereby garages typically no longer have this replacement part, then a particular garage can be selected, and an appointment for exchanging the corresponding part can be made at this garage for all the vehicles. Simultaneously, the central management device orders a sufficiently large quantity of the corresponding replacement part for the service provider, i.e., this one selected garage, from a replacement part delivery service, for example from a vehicle manufacturer. Due to the high number of ordered replacement parts, the specific garage can receive a volume discount. Synergy effects are thus created, which lead to profit maximization both for the vehicle fleet operator and also for the service provider.

In general, it is also conceivable that artificial intelligence is used by the central management device, in order to plan management processes as optimally as possible, for example in order to manage the vehicle fleet.

A further example for the reduction of total costs is booking a service to be carried out particularly quickly. Thus, for example, a first service provider can offer only a stationary service, and a second service provider, for example Germany's automobile association, ADAC, can also offer a mobile service. If the downtime for the vehicle is, for example, greater if the vehicle must first travel to the first service provider than if the service is carried out by the mobile service provider at the location of the vehicle, then the mobile service provider for carrying out the service is booked. While taking into account the total costs for the vehicle fleet manager, the service provider with the greater downtime for the vehicle can by contrast also be booked if the costs for carrying out the service via the mobile service provider outweigh the costs of a longer downtime.

By means of a cost function, and correspondingly selected weighting factors, the vehicle fleet manager can determine which aspect is more important. The shorter downtime of the vehicle can thus also be more relevant for the vehicle fleet manager despite higher costs. The vehicle fleet manager can thus build a better reputation with their own customers, for example, because the vehicles operated by them have a higher availability than the vehicles of a competing vehicle fleet operator. The vehicle fleet operator can thus earn increased customer satisfaction.

A service provider for providing the service can also be selected by the central management device while taking into account at least one piece of fleet management information. For example, a particular vehicle fleet manager can have negotiated discount contracts with a particular number of service providers. These service providers are correspondingly preferably selected.

At least one piece of environment information can also be taken into account to select a suitable service provider. If, for example, a traffic jam or stagnant traffic lies on a route ahead of a vehicle to the first service provider, then a journey time to a second service provider that is further away can be shorter. If the second service provider then spontaneously has an appointment free, the service can be provided by the second service provider, because the downtime for the vehicle can thus be reduced.

In general, although the trigger for booking a service is thus based on learned, and thus historical data, real-time data such as traffic data, weather data, data for big events or car park data is included in the ultimate implementation of the service, however.

Depending on where the vehicle should be used after the service is provided, the traffic volume after the service has been provided can also be estimated, and the selection of the service provider can be correspondingly adjusted, such that such a service provider is selected at which the total downtime of the vehicle is minimal. To estimate the journey time of a vehicle, infrastructure information, such as the presence of traffic lights, building sites and/or diversions on a route driven by a vehicle can be taken into account.

Further, weather information can also be taken into account for booking an appointment for providing a service at a service provider. Furthermore, weather-dependent situations can trigger the booking of an appointment, which suggest a cleaning of the vehicle to the management platform when there is a lot of precipitation/snow/bad weather or can plan the preference of the fleet operator corresponding to an action, which can be stored in the system. The same applies, for example, if it is known from the internal datasets in the ISOP that it would be necessary to wash the vehicle, but the weather data indicates a significant probability of rain in the particular area. In this case, vehicle washing is withheld on the basis of real-time data and parked in the system.

Or in the opposite exemplary case: If, for example, the vehicle is washed and/or waxed, and should, for example, be used for transporting a VIP following the provision of the service, then a constraint can be that the vehicle cannot get wet after the service is provided. If, for example, precipitation is then expected in a particular region and/or at a particular period of time, the carrying out of the service is planned, booked and carried out such that the vehicle does not get wet before the planned use.

A further advantageous embodiment of the method according to the invention provides that at least one of the following services is provided:
a repair of at least one vehicle component;
maintenance;
towing of the vehicle
carrying out roadside assistance;
carrying out a relocation service;
cleaning and/or caring for at least one vehicle component;
filling an energy storage device of the vehicle;
locating a lost object;
activating or deactivating;
applying for and carrying out a vehicle registration;
carrying out a diagnosis
carrying out a software update
vehicle handover without a key
carrying out a vehicle security diagnosis to avoid and track theft; and/or
carrying out the shutdown of a vehicle, so-called remote immobilization.

During the operation of the vehicle, at least one vehicle component can be damaged, for example due to aging, wear and/or an accident. By repairing the corresponding component, the vehicle can be made ready for use again.

The maintenance of the vehicle can, for example, comprise a regular inspection.

In particular to carry out roadside assistance, to tow the vehicle or to carry out a relocation service, and thus a relocation of the vehicle from a first location to a second location, a mobile service provider is required.

The vehicle can generally comprise an internal combustion engine and/or an electric drive engine. It can thus be an internal combustion vehicle, hybrid vehicle, or a vehicle driven purely via electric battery. In particular, vehicles driven purely by electric battery have a lower range in comparison, which requires a traction battery of such a vehicle to be frequently charged. Because the operation of the fleet vehicles is planned, it can also be comparatively accurately estimated when such a charging process is due. Correspondingly, suitable charging stations for charging the traction battery are determined in a timely manner by the central management device, and operating pauses are planned such that the respective vehicles are charged in as cost-efficient and as time-efficient a manner as possible.

Because fleet vehicles are typically used by a plurality of different people, it can be the case that a particular person in a particular vehicle loses or forgets an object, for example a key, a wallet, or a smartphone. The corresponding person can contact the vehicle fleet manager, or for example contact the central management device directly via an online service, and inform them about the lost object. The central management device then automatically instructs a person to search the corresponding vehicle for the lost object. This can also take place by means of camera-controlled technology in and around the vehicle, for example in autonomous vehicles.

Vehicles increasingly have complex computers such as a central on-board computer or control devices of vehicle sub-systems. Software is run by these computers to fulfil their tasks. Such software can be updated by means of software updates. Thus, for example, new functions can be installed and/or security gaps can be closed. Such a software update can, in particular, be transmitted to vehicles over the air. For vehicles without over the air functionality, a software update must be provided manually on the computer, for example via wires or by inserting a portable storage medium, such as a USB stick or an SD card, into a corresponding port of a computer of the vehicle. Carrying out such a manual software update can also be a service to be carried out in the context of the method according to the invention.

Corresponding to a further advantageous embodiment of the method according to the invention, the central management device acts as an intermediary between at least two service providers, in particular to make it possible for a first service provider to provide the service completely by obtaining required resources from at least one second service provider. As the central management device also acts directly as an intermediary between at least two service providers, a degree of automation of the method according to the invention, and thus of the vehicle fleet management, can be even further increased. As already mentioned, it can for example be made possible to maintain delivery chains particularly efficiently. If, for example, a particular vehicle requires a particular replacement part, then the central management device can order a corresponding replacement part from a part delivery service for a corresponding garage. The garage can, for example, pre-determine constraints applying to a transaction. For example, the garage can pre-determine that only a maximum number of replacement parts should be ordered at a pre-determined price. Correspondingly, this information is transferred from the central management device of the garage to the part delivery service or taken into account.

When a resource is required, the resource can be a physical component, such as a part, replacement part or the like. A resource can also, for example, be a person, and thus a service employee and/or time. Thus, for example, an additional employee can be requested, in order to provide a particular service more quickly. A vehicle can also require that several service providers must be visited one after the other to fulfil a particular service need. Correspondingly, the central management device plans for such a service to be carried out, such that the individual service portions to be carried out are distributed to the individual service providers in a time-efficient manner.

A further advantageous embodiment of the method further provides that a vehicle fleet comprises at least two vehicles of different vehicle manufacturers, and a service that is individualized for the manufacturer is offered to these vehicles. Comparatively large vehicle fleets, in particular, use vehicles of different manufacturers. Individual vehicles of different types can also be used, e.g., pick-up trucks, vans, transporters, passenger cars, e-scooters, or the like. In such a case, it can be ensured using the method according to the invention that the complete vehicle fleet of the vehicle fleet manager is also managed, i.e., the appropriate vehicle-related services can be arranged for each vehicle.

Preferably, at least one vehicle of a vehicle fleet can be controlled in an automated manner, and after booking a service, the vehicle automatically finds a service provider and/or travels from the service provider to a planned starting location after the service is provided. Because at least one vehicle can be controlled automatically, the degree of automation of the method according to the invention can be increased even further. Thus, for example, no people are required to take a corresponding vehicle from its respective stopping place to a place in which a service provider is located, for example a particular garage, a particular car wash or the like. Vehicles can also receive control commands from the central management device or via a vehicle control center.

For a fleet management platform having an infrastructure formed by hardware and software and at least one interaction interface, the infrastructure and the interaction interface are equipped according to the invention to carry out a method described above.

Hardware in the form of central servers and distributed computers, mobile devices, or the like serve to implement the fleet management platform. Software is run on the corresponding hardware components. Thus, for example, software run on at least one server can carry out calculations to implement the functionalities provided by the central management device. On a personal computer or a mobile device, a client can, for example, be run, with which, for example, a vehicle fleet manager can retrieve information about its vehicle fleet and/or give instructions to carry out particular services. A service provider can also access the fleet management platform via a corresponding client and be listed on the platform and make the API interfaces of its own systems available, as, for example, garage systems, fleet software systems, traffic systems, or smart city data systems. The interaction interface serves, on the one hand, for people to access the fleet management platform to obtain information and/or give commands. The final expansion stage of the intelligent platform ISOP aims to be a marketplace. Service providers of all kinds will be able to register via a web application for this system. Necessary explicit datasets are queried, for example the competencies of the firm or the presence of particular devices, e.g., car washes, charging infrastructure, or paintworks. The opening times and the data interfaces can also be queried in the respective API dealer management system.

At least one interaction interface also serves to transmit data between technical systems and/or technical systems and people. Data can be communicated in any way, in particular via wires and/or wirelessly. For example, data can be exchanged via the internet between individual actors of the fleet management platform.

For example, a customer of a car-sharing service can book a particular vehicle for a particular period of time or a particular distance with a vehicle fleet manager. The corresponding person indicates that they would like to receive the vehicle at a particular starting location. The respective vehicle must then first be brought to the starting location. A server operated by the vehicle fleet manager to provide the car-sharing service then contacts the central management device, and shares with the latter that there is an instruction to take a vehicle to the starting position requested by the customer of the car-sharing service. The central management device then automatically contacts a service provider who offers a relocation service. An employee of the relocation service is sent an instruction on their smartphone to fetch a particular vehicle and to take it to the desired starting location of the customer of the car-sharing service. Additional information can also be transmitted to the employee, e.g., a digital vehicle key. The central management device automatically selects the employee who can bring the corresponding vehicle to the starting place requested by the customer at an optimal point in time. Thus, as far as possible, the vehicle is brought to the starting location such that it arrives at the starting location shortly before the customer arrives. The vehicle can thus be used for further journeys beforehand. Correspondingly, the central management device selects an employee for the transfer who also has free capacity in the period of time in which the vehicle should be brought to the starting location.

Further advantageous embodiments of the method according to the invention for arranging vehicle-related service providers and of the fleet management platform also result from the exemplary embodiments, which are described in more detail in the following with reference to the figures.

### BRIEF DESCRIPTION OF THE DRAWING FIGURES

Here:

FIG. 1 shows a schematic depiction of a method according to the invention for arranging vehicle-related services of participating actors; and

FIG. 2 shows a simplified depiction of a basic sequence for the arrangement of vehicle-related services according to the method according to the invention.

### DETAILED DESCRIPTION

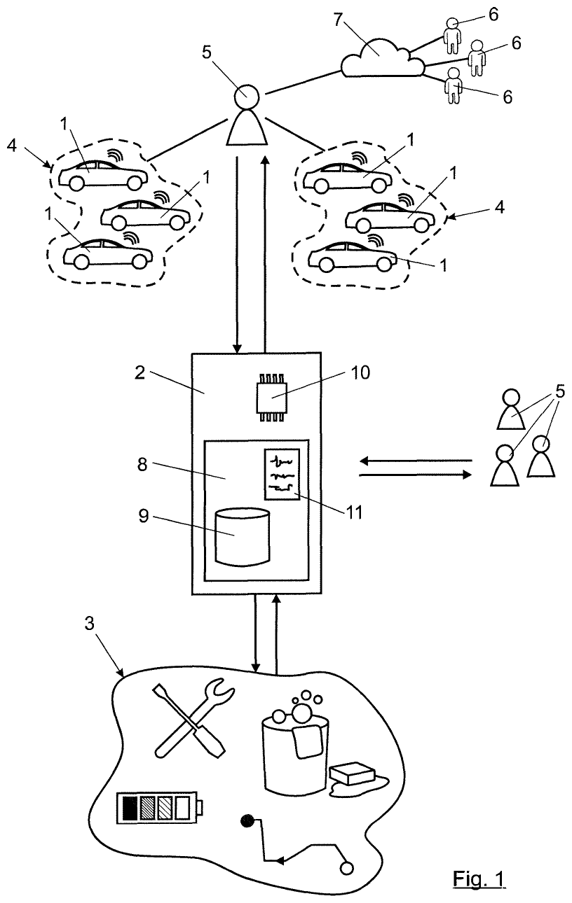

FIG. 1 shows several vehicles 1, which together form a vehicle fleet 4. The vehicle fleet 4 is operated by a vehicle fleet manager 5. A vehicle fleet manager 5 can also operate several vehicle fleets 4 simultaneously. A first vehicle fleet 4 can, for example, be a fleet of car-sharing vehicles, and a second vehicle fleet 4 can, for example, be used by an end customer 6 of the vehicle fleet manager 5 for its own services. The end customer 6 can, for example, be a supermarket chain, who deliver supermarket goods to their own customers with the vehicles 1 of the respective vehicle fleet 4.

The end customers 6 of the vehicle fleet manager 5 can, for example, make use of a service offered by the vehicle fleet manager 5 via a customer platform 7. Thus, for example, an end customer 6 can book a particular vehicle 1 via the customer platform 7 to carry out a journey.

During the operation of the individual vehicle fleets 4, individual vehicles 1 can determine a service need, and communicate the latter. It is thus necessary, for example, for a particular vehicle 1 to be cleaned, to be maintained, to be repaired, to be brought from a first location to a second location, to bring an object lost in a particular vehicle 1 back to its original end customer 6 or the like.

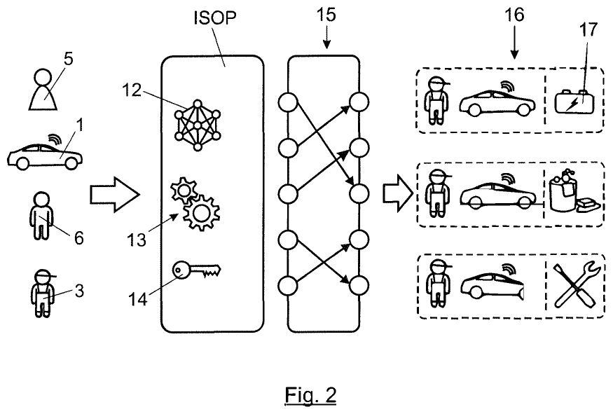

Different service providers 3 are available to carry out such services. For a vehicle fleet manager 5, the question arises of how to bring vehicles 1 for which a service needs to be performed to individual service providers 3 in as time-efficient and/or cost-efficient a manner as possible. This task is taken over while carrying out a method according to the invention by a fleet management platform ISOP (Intelligent Service Orchestration Platform) according to the invention, which is depicted in FIG. 2.

The fleet management platform ISOP is formed by a hardware and software infrastructure. For this purpose, a central management device 2 is provided, which can, for example, be designed as a cloud server or a server network. The central management device 2 comprises at least one storage element 8, for example a hard drive or a flash storage device, which in turn comprises at least one database 9 and/or program code 10. The database 9 can, for example, comprise rules 12, which are also shown in FIG. 2, which set the conditions according to which vehicle-related services are arranged. The program code 10 then serves to implement these rules 12 via a processor 11.

The central management device 2 receives data from the vehicle fleet manager 5, the vehicles 1 and/or the service providers 3 and environment data, e.g., weather data, information about large events/events or traffic data. Depending on the rules 12 applied, vehicles 1 with a service need for the vehicle fleet manager 5 are then brought to suitable service providers 3 in a time-efficient and/or cost-efficient manner. In particular, the central management device 2 is equipped to simultaneously oversee several different vehicle fleet managers 5. The central management device 2, and thus the fleet management platform ISOP can, for example, be operated by a vehicle manufacturer. The fleet management platform thus fulfils the function of a marketplace for fleet managers 5 or fleet operators and service providers 3.

FIG. 2 shows a simplified depiction of a basic sequence of the arrangement of such vehicle-related services.

The fleet management platform ISOP receives information from at least one vehicle fleet manager 5, at least one vehicle 1, and/or at least one service provider 3. Thus, for example, the vehicle fleet manager 5 can manually give an instruction to carry out a particular service. Analogously, a particular vehicle 1 can report a self-determined service need to the fleet management platform ISOP. For this purpose, the vehicle 1 can, for example, evaluate diagnostic data and/or error codes, and thus, for example, recognize the requirement to carry out an oil service. The service providers 3 can, for example, share with the management platform ISOP at what service times services are offered and at which times on what days capacity for carrying out services is free. A service provider 3 can also share with the fleet management platform ISOP which costs it has calculated for performing which services.

In an advantageous embodiment, end customers 6 of a vehicle fleet manager 5 can also transmit information to the fleet management platform ISOP. An end customer 6 can thus give feedback, for example, or for example directly inform the vehicle fleet manager 5 or the fleet management platform ISOP that, for example, a particular vehicle 1 is damaged. In order to avoid misuse, a corresponding vehicle 1 can comprise sensors, using which a defect or accident can be determined. For example, the vehicle 1 can comprise an interior camera, whereby camera images generated by the interior camera are evaluated using image recognition algorithms, for example in order to determine a dirty car seat, a crack in a dashboard or the like.

The fleet management platform ISOP comprises rules 12, which are used to assign vehicles 1 to service providers 3. The fleet management platform ISOP further comprises means 13 for initiating the carrying out of a service. The fleet management platform ISOP is thus in the position to directly book appointments for providing services at a service provider 3. As an alternative, a piece of information can also be displayed to the vehicle fleet manager 5, showing which service provider 3 is most suitable at which points in time and under which conditions to carry out a service, whereupon the vehicle fleet manager 5 can decide manually whether the corresponding service should be booked with the respective service provider 3 or not.

In addition, it is possible to integrate different data sources and ecosystem partners to optimize the fleet workflow and make it more automated.

The data sources can, for example, be weather data, insurance data, garage system data, smart city data, traffic data, fleet vehicle data, or sensor data from and around the vehicle. These data sources are aggregated for the past, but real-time data can also be used, in order to give the best possible action recommendation to the fleet operator. The ecosystem partners are, in particular, fleet management system providers, service providers such as garages, charging stations, car washes, petrol stations, insurance providers, shared mobility fleet providers, vehicle rental providers, payment providers, automobile manufacturers, car delivery services, mobile network providers, cloud infrastructure providers, or sensor providers. There is thus no rigid system of rules on the fleet management platform, and instead the recommendations for fleet use are continually adapted. Recommendations can thus be made based on the data, for example: “Fleet customers who drive these similar routes changed the fleet to electric vehicles” or “fleets which are on the road in large numbers at this time of year move the cleaning/maintenance works to a particular service center, because a lower workload is expected there.”

The fleet management platform ISOP can also comprise an access control 14 to control access to at least one vehicle 1, and transmit the access control to the individual employees of a service provider 3 to enable an access to the corresponding vehicle 1. For example, the access control 14 can be a digital vehicle key. Such a digital vehicle key can, for example, be transmitted to a mobile device such as a smartphone, whereupon for example the corresponding vehicle 1 can be unlocked using a suitable app. The mobile end device can, for example, exchange ultra-wideband communication data with the vehicle 1. The access control 14 can, for example, be a combination of usernames and passwords, with which a vehicle fleet manager 5, end customer 6 and/or service provider 3 can register with a vehicle fleet management client. The vehicle fleet management client offers the different entities, and thus the vehicle fleet manager 5, the end customers 6 and the service provider 3 different functionalities, as already mentioned.

Corresponding to the rules 12, vehicles 1 and service providers 3 are assigned to each other in a method step 15.

In the method step 16, a particular service is booked to be carried out by a particular service provider 3 for a particular vehicle 1. For example, a service provider 3 should charge a traction battery 17 of a vehicle 1, clean the inside and/or outside of a vehicle 1 or carry out an inspection on a regular basis.

Using the method according to the invention and the fleet management platform ISOP according to the invention, ISOP standing for “Intelligent Service Orchestration Platform”, it is possible to make it possible for a vehicle fleet manager 5 to save time and to reduce operating costs for their vehicle fleet 4. In particular, the total cost of ownership (TCO) for operating a vehicle fleet 4 can be reduced. The vehicle fleet manager 5 thus has means of better planning the services for their vehicles 1.

The described fleet management platform is thus a mobility and automation platform for fleet-based and fleet-controlled businesses. It unites and strengthens the effect of fleets, telematics, and other internal systems which are already in use, and the systems of providers to create a continuous digital transformation in order to optimize fleets and business processes. The platform is an SaaS (Software as a Solution) and PaaS platform. PaaS (Platform as a Service) is a cloud computing model, in which a third-party provider provides hardware and software tools for users via the internet. The platform thus automates all operative activities which arise in fleet management.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for arranging vehicle-related services, the method comprising:
determining, by a vehicle, a service need;
transmitting, by the vehicle to a central management device, the service need together with additional data;
offering, by at least one service provider, at least one service;
transmitting, by the at least one service provider to the central management device, service provision information for providing the at least one service to the central management device; and
producing, by the central management device responsive to receipt of the service provision information and the service need, a contact between the vehicle and the at least one service provider to provide the at least one service,
wherein the vehicle belongs to a vehicle fleet,
wherein the additional data comprises at least one use of the vehicle planned within a pre-determined period of time, and
wherein the central management device automatically suggests or books an appointment for the vehicle for the provision of the at least one service, taking into account the planned use of the vehicle and the service provision information, such that a downtime for the vehicle due to the provision of the at least one service or costs associated with operation of the vehicle fleet is minimized.

10. The method of claim 9, wherein the vehicle determines the service need, taking into account at least one of the following parameters:
a distance covered within a pre-determined period of time by the vehicle;
a pre-determined elapsed period of time that is a service interval;
diagnostic data recorded by the vehicle;
an error code output by a subsystem of the vehicle;
information about an occurring accident event; or
a current or estimated energy reserve of an energy storage device of the vehicle.

11. The method of claim 9, wherein the central management device determines the at least one service provider for providing the service, taking into account at least one of the following pieces of information:
at least one of the following pieces of service provision information
service times of the at least one service provider, free capacities of the at least one service provider, a competency of the at least one service provider, a location at which the at least one service provider offers the service, mobility of the at least one service provider, costs, or an availability of parts;
at least one of the following pieces of fleet management information
a unique vehicle identifier, a current or planned stopping place of the vehicle, a number of booked services, or the presence of a discount agreement, or
at least one of the following pieces of environment information
a current or future traffic volume on a route driven by the vehicle before or after the service is provided, infrastructure information, or weather information.

12. The method of claim 9, wherein the at least one service is:
repair of at least one component of the vehicle;
maintenance of the vehicle;
towing of the vehicle;
carrying out roadside assistance for the vehicle;
carrying out a relocation service of the vehicle;
cleaning or caring for at least one component of the vehicle;
filling an energy storage device of the vehicle;
locating a lost object in the vehicle;
activating or deactivating the vehicle;
applying for and carrying out a vehicle registration for the vehicle;
carrying out a diagnosis of the vehicle;
carrying out a software update of the vehicle;
vehicle handover without a key;
carrying out a vehicle security diagnosis to avoid and track theft of the vehicle; or
carrying out shutdown of the vehicle by remote immobilization.

13. The method of claim 9, wherein the central management device acts as an intermediary between at least two service providers so that a first of the at least two service providers provides the at least one service completely by obtaining required resources from at least one second service provider of the at least two service providers.

14. The method of claim 9, wherein the vehicle fleet comprises at least two vehicles of different vehicle manufacturers, and a service individualized for the different vehicle manufacturers is offered to the at least two vehicles.

15. The method of claim 9, wherein the vehicle is controlled automatically, and after booking a service, the vehicle automatically finds a service provider or travels from the at least one service provider to a planned starting location after the at least one service is provided.

16. A fleet management platform, comprising:
a central management device configured to
determine, by a vehicle, a service need;
receive, from a vehicle, a service need determined by the vehicle together with additional data;
receive, from at least one service provider, service provision information for providing the at least one service to the central management device; and
produce a contact between the vehicle and the at least one service provider to provide the at least one service,
wherein the vehicle belongs to a vehicle fleet, Page 7
wherein the additional data comprises at least one use of the vehicle planned within a pre-determined period of time, and
wherein the central management device automatically suggests or books an appointment for the vehicle for the provision of the at least one service, taking into account the planned use of the vehicle and the service provision information, such that a downtime for the vehicle due to the provision of the at least one service or costs associated with operation of the vehicle fleet is minimized.
